(19) United States
(12) Patent Application Publication
(10) Pub. No.: US 2024/0272806 A1
(43) Pub. Date: Aug. 15, 2024

(54) MEMORY DEVICE CACHE SYNCHRONIZATION

(71) Applicant: Micron Technology, Inc., Boise, ID (US)

(72) Inventors: Luca Porzio, Casalnuovo (NA) (IT); Christian M. Gyllenskog, Meridian, ID (US)

(21) Appl. No.: 18/424,492

(22) Filed: Jan. 26, 2024

Related U.S. Application Data
(60) Provisional application No. 63/445,909, filed on Feb. 15, 2023.

(51) Int. Cl. G06F 3/06; G06F 12/0815

(52) U.S. Cl. CPC G06F 3/0619; G06F 3/0659; G06F 3/0679; G06F 12/0815

(57) ABSTRACT

Methods, systems, and devices for memory device cache synchronization are described. Some implementations may synchronize a cache after a power loss event. For example, during normal operation, a memory system may move data from a cache to a non-volatile memory. Each data may be assigned a sequential identifier when being moved. After a power loss event, the memory system may determine which data has been moved to the non-volatile memory (e.g., based on the identifiers) and may assume that data associated with the identifiers stored to the non-volatile memory is valid, whereas data associated with other identifiers not present in the non-volatile memory is invalid. The memory system may then recover the valid data by copying the valid data to the cache.

### CROSS REFERENCE

The present application for patent claims priority to and the benefit of U.S. Provisional Application No. 63/445,909 by Porzio et al., entitled “MEMORY DEVICE CACHE SYNCHRONIZATION,” filed Feb. 15, 2023, assigned to the assignee hereof, and is expressly incorporated by reference in its entirety herein.

### FIELD OF TECHNOLOGY

The following relates to one or more systems for memory, including memory device cache synchronization.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports memory device cache synchronization in accordance with examples as disclosed herein.

FIG. 2 illustrates an example of a file system that supports memory device cache synchronization in accordance with examples as disclosed herein.

FIG. 3 illustrates an example of a command sequence that supports memory device cache synchronization in accordance with examples as disclosed herein.

FIG. 4 illustrates a flowchart showing a method or methods of a command sequence that supports memory device cache synchronization in accordance with examples as disclosed herein.

FIG. 5 illustrates a block diagram of a memory system that supports memory device cache synchronization in accordance with examples as disclosed herein.

FIG. 6 illustrates a flowchart showing a method or methods that support memory device cache synchronization in accordance with examples as disclosed herein.

### DETAILED DESCRIPTION

Methods, systems, and devices for memory device cache synchronization are described. There are many different types of memory systems, including volatile and non-volatile memory systems. Volatile memory may need power to maintain its data and non-volatile memory may provide persistent data by retaining stored data if not powered.

If an event causes a system to lose power unexpectedly such that it cannot complete a controlled shutdown or reboot, a cache or other volatile memory may lose data. This unexpected loss of power may be referred to as an asynchronous power loss. An asynchronous power loss may also cause some data to be invalid. If invalid data is written to the cache after an asynchronous power loss, the memory system may experience a failure. To improve system reliability and assist in recovering data upon an asynchronous power loss or a similar event, many systems include mechanisms to write data stored in a cache to non-volatile memory. Writing the data to non-volatile memory may improve data reliability, but it may also impact system performance. While performing a command to write data from the cache to non-volatile memory, for example, other write commands within the system might be paused, which may increase the latency of the system.

In certain implementations of memory systems, asynchronous power loss or other similar events may occur. Such power loss events may occur based on a host system losing power or a sub-system of the host system losing power (e.g., the memory system). Losing power may result in the loss of data, data becoming invalid, or both. If invalid data is written to the cache after an asynchronous power loss, the memory system may experience a failure. Measures to increase system reliability during these events may increase system latency. For example, performing write instructions from a cache to non-volatile memory and pausing other write instructions may cause increased latency for performing commands issued by the host system.

In addition to applicability in memory systems as described herein, techniques for cache synchronization may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by facilitating more cache synchronization, which may decrease failure rates, decrease latency, or otherwise improve user experience, among other benefits.

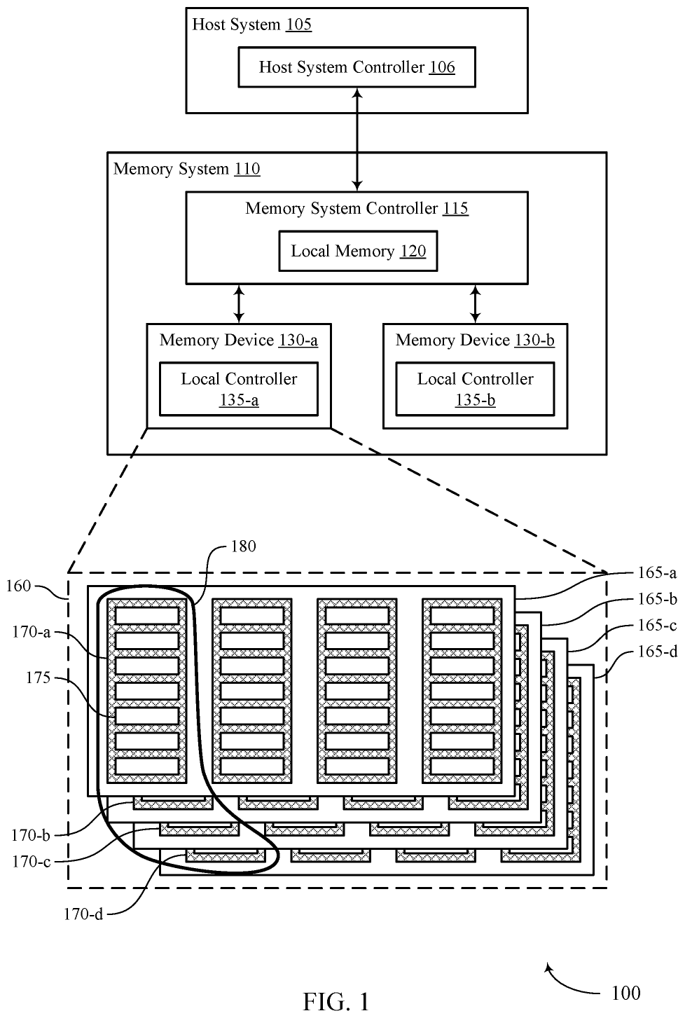

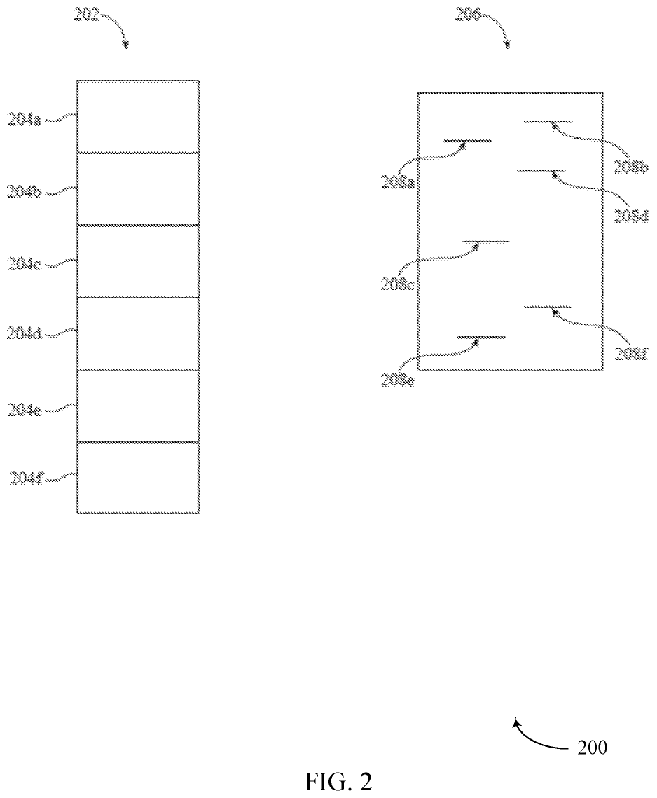

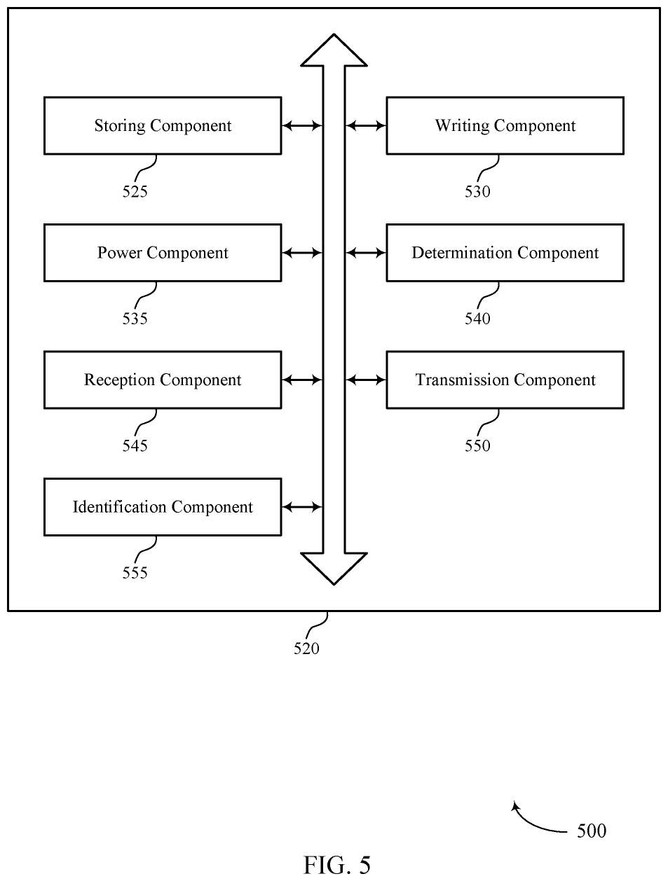

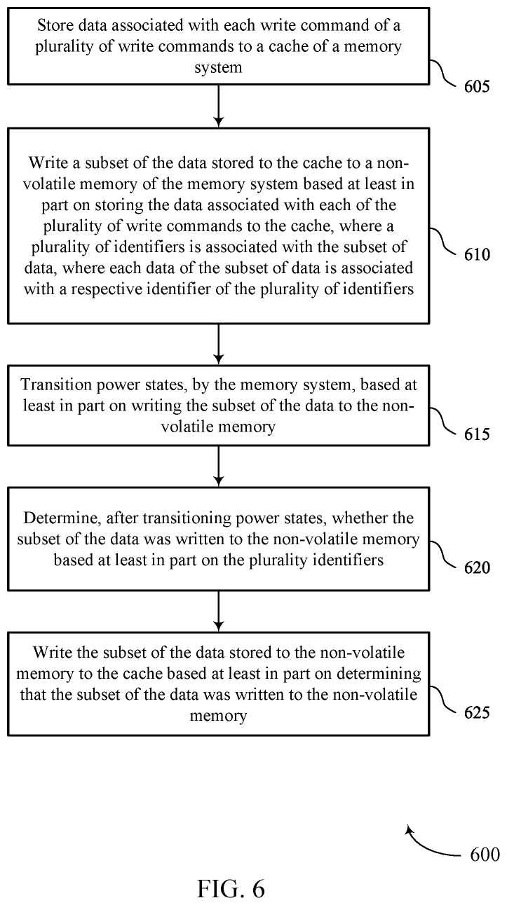

Features of the disclosure are initially described in the context of systems, devices, and circuits with reference to FIG. 1. Features of the disclosure are described in the context of a file system, a command sequence, and a process flow diagram with reference to FIGS. 2 through 4. These and other features of the disclosure are further illustrated by and described in the context of an apparatus diagram and flowchart that relate to memory device cache synchronization with reference to FIGS. 5 and 6.

FIG. 1 illustrates an example of a system 100 that supports memory device cache synchronization in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with one or more host system controllers 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include one or more memory system controllers 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The one or more memory system controllers 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including one or more memory system controllers 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) one or more local controllers 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the block 170 that includes the page 175 has been erased.

In some cases, a memory system 110 may utilize one or more memory system controllers 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support memory device cache synchronization. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, the memory system 110 may include local memory 120 that may serve as a cache. In some examples, the memory system 110 may include one or more separate and/or additional caches. The system 100 may support implementations described herein by synchronizing the local memory 120, which may serve as a cache (e.g., a volatile memory) after a power loss event (e.g., an asynchronous power loss). For example, during normal operation, the memory system 110 may move (e.g., write) data from a cache 120 to a memory device 130 or other non-volatile memory. Each data may be assigned a sequential identifier (e.g., a “1,” a “2,” etc.) when being moved. After a power loss event, the memory system 110 may determine which data has been moved to the memory device 130 and may assume that data associated with the identifiers stored to the memory device 130 is valid, whereas data associated with other identifiers not present in the memory device 130 is invalid. The memory system 110 may then recover the valid data by copying (e.g., writing) the valid data to the cache 120 upon power-on. By writing the valid data to the cache 120, the memory system 110 can recover the prior data (e.g., the data written to the memory device 130) faster after a power loss event, which may improve the overall performance of the memory system.

FIG. 2 illustrates an example of a memory system 200 that supports memory device cache synchronization in accordance with examples as disclosed herein. The memory system 200 may be an example of aspects of a memory system as described with reference to FIG. 1. The memory system 200, or various components thereof, may be an example of means for performing various aspects of memory device cache synchronization as described herein. For example, the memory system 200 may include a file system 202 and a memory device 206.

In some examples, a file system 202 may include one or more entries 204a-f in an index. Each entry 204a-f may be a pointer that may point to a location 208a-f of a memory device 206 (e.g. non-volatile memory). For example, each entry 204a-f may be utilized for logical block addressing (LBA). Each location 208a-f may be the location of a block of data stored at the memory device 206. A memory system 200 may verify that the data is valid and stored in the location 208a-f indicated by the file system 202. For example, the memory system 200 may perform a memory device cache synchronization. The memory device cache synchronization may include instructions to write data from a cache or volatile memory to a memory device 206 or non-volatile memory. In some examples, the file system 202 may include an index that may be written to the memory device 206 at a data point or location 208a-f of the memory device 206. A location 208a-f may include the file system data or index itself. The system 200 may assume that data pointed to by the entries 204a-f is stored on the memory device 206 in the locations 208a-f.

In some examples, the file system 202 indexing may need to be updated and the memory system 200 may verify that the data is present in the location 208a-f indicated by the entries 204a-f. The memory system 200 may perform a synchronization to verify that the data is present in the location 208a-f indicated by the entries 204a-f. File systems are one example of where this may occur. Another example includes databases. In these examples, the memory system 200 may ensure that the data is present in memory device 206 so the file system 202 can be updated and so that the updated file system 202 can be utilized during subsequent operations.

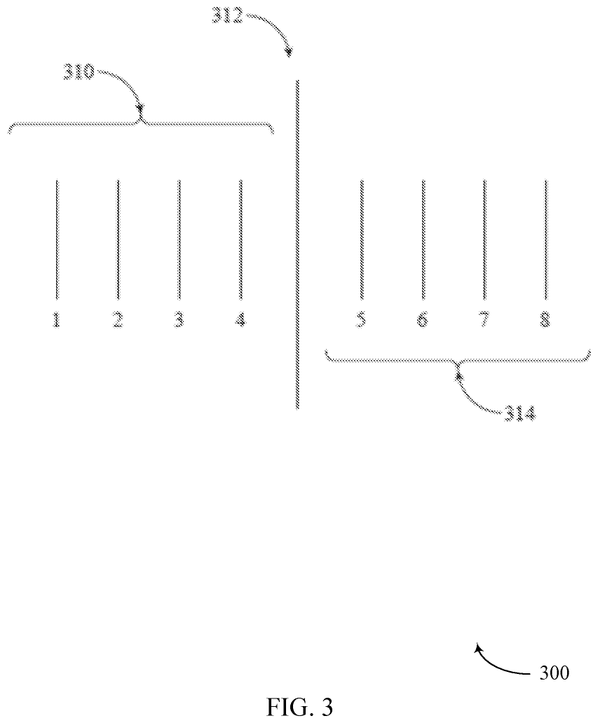

In some examples, there may be operations between a host system (e.g. the host system 105 in FIG. 1) and a memory system 200 where the host system receives confirmation from the memory system 200 that a write occurred successfully. For example, the memory system 200 may receive a synchronization command or instructions to write data from the cache to the memory device 206. Some examples of a synchronization command may include a Force Unit Access (FUA) instruction or a synchronize cache (e.g., a SYNC_CACHE) instruction. The memory system 200 may perform the synchronization command by writing data from the cache to the memory device 206. If the data is written on the memory device 206, the memory system 200 may reply and inform the host system an additional operation may be performed. In these examples, there may be a delay caused by waiting for the synchronization command to be completed before starting additional operations. Waiting for the synchronization command to be completed may cause a delay in performing additional operations until after the synchronization command is complete. An illustration of a command sequence that supports memory device cache synchronization is illustrated in FIG. 3.

FIG. 3 illustrates an example of a command sequence 300 that supports memory device cache synchronization in accordance with examples as disclosed herein. In some examples, a cache (e.g., a volatile memory) may be synchronized after a power loss event (e.g., an asynchronous power loss). For example, during normal operation, a memory system may move data from a cache to a non-volatile memory. The data may be assigned a sequential identifier (e.g., a “1,” a “2,” etc.) when being moved. After a power loss event, the memory system determine which data has been moved to the non-volatile memory (e.g., based on the respective identifiers) and may assume that data associated with the identifiers stored to the non-volatile memory is valid, whereas data associated with other identifiers not present in the non-volatile memory is invalid. The memory system may then recover the valid data by copying (e.g., writing) the valid data to the cache. By writing the valid data to the cache, the memory system can recover the prior data (e.g., the data written to the non-volatile memory) faster after a power loss event, which may improve the overall performance of the memory system.

In some examples, a command sequence 300 may include one or more write commands grouped into subsets of data 310, 314. A synchronize command 312 may also be present in the command sequence 300 and may be present between write commands for a first subset of data 310 and write commands for a second subset of data 314. There may be one or more write commands for the first subset of data 310 sequentially before the synchronize command 312 and one or more write commands for the second subset of data 314 that may occur after the synchronize command 312. In some examples, write commands for the first subset of data 310 may be assigned sequential identifiers (e.g., 1, 2, 3, 4) and write commands for the second subset of data 314 may be assigned additional sequential identifiers (e.g., 5, 6, 7, 8). The command sequence 300 may occur over time and be arranged in an order based on when respective commands are received. For example, write commands for the first subset of data 310 may be execute, a synchronize command 312 may be executed, and a write command for the subset of data 314 may be executed.

In some examples a memory system (e.g., memory system 200 of FIG. 2) may update internal structures or pointers of a file system (e.g. file system 202 of FIG. 2). In one example, a synchronize cache operation may occur if an application is closed. If an application is closed, a file system may attempt to ensure that data from the application is stored to the memory system (e.g., from a cache), so a synchronize cache operation may occur. A synchronize cache operation may cause latencies, however. One source of latency may occur due to write operations being paused until the synchronize cache operation is complete. This may cause a delay in the write operations being performed and result in added latency. In addition, the memory system may verify that the data has been written to the non-volatile memory before subsequent write operations are performed. For example, the latency caused by a synchronize cache operation, or the like, might add between 100 microseconds and several milliseconds or more to operations occurring at the memory system. One example of a synchronize cache command may be referred to as “SYNC_CACHE,” which may write volatile data from a cache to non-volatile memory in some memory systems. The SYNC_CACHE command may ensure that data received (e.g., from a host system) has been written to a non-volatile memory.

One example of a cache might be static random-access memory (SRAM) of a universal flash storage (UFS) device or a managed NAND device, or the like. Another example may be dynamic random access memory (DRAM) in a Small Computer Systems Interface (SCSI) device, or the like. A cache may be any type of volatile data included within a memory system.

In some examples, an asynchronous power loss (e.g., an unexpected loss of power without a controlled shut down) may cause the loss of volatile data. In some examples, an asynchronous power loss may occur if a power source, such as a battery, is disconnected or removed from a device. A memory system may perform operations to validate data that is present after an asynchronous memory loss, or the like.

In some examples, a memory system may write a first subset of the data 310 stored to the cache to a non-volatile memory of the memory system. A plurality of sequential identifiers (e.g., 1, 2, 3, 4) may be associated with the first subset of data 310. The memory system may transition power states, for example, during an asynchronous power loss. After transitioning power states, the memory system may determine whether the first subset of data 310 was written to non-volatile memory based on the plurality of identifiers. If it is determined that the first subset of data 310 is written to the non-volatile memory, the first subset of data 310 may be written to the cache (e.g., written back to the cache).

In some examples, a memory system may be operable in one or more different modes of operation. One mode of operation may be referred to as a second mode or a “lazy” mode. A second mode may allow a memory system to determine that instructions received to perform a synchronize cache command, or the like, may be performed if instructed by a host system, or may be delayed and performed at a later time as determined by the memory system. At a protocol level, a second mode or lazy mode may allow the memory system to not honor, for example a FUA command or synchronize cache command, or the like, and instead execute the FUA command or synchronize cache command at a later time. This may allow the memory system to manage the cache and synchronization commands, or the like, rather than being managed by a host system. In some examples, a memory device may choose not to honor or not honor FUA commands, synchronize cache commands or the like, based on a configuration received from a host system.

If a memory system experiences an asynchronous power loss, or the like, and recovers power, the memory system may determine what data needs to be restored. The memory system may utilize an identifier or order of commands that were received to recover data in the order of the sequence value. For example, if the memory system can recover data associated with the identifiers 1, 2, 3, and 4 but can't recover data associated with the identifier 5, data beyond the first failing sequence value may not be recovered and may be considered to be invalid. For example, data associated with any identifiers from 6 and above may be considered invalid. By not recovering data beyond the first failing sequence value, the memory system may ensure that the data recovered is valid or stable.

In some examples if the system is in a first mode or “normal” mode, if there is a synchronize cache command, or the like, completed successfully between sequence values, the system may consider the sequence prior to the synchronize cache command to be valid. For example, if a synchronize cache command is completed successfully between identifier 4 and identifier 5, the system may consider data associated with identifiers 1-4 to be valid and data associated with identifiers 4-8 to be valid. If the system assumes that data associated with the identifiers 4-8 are invalid, the system may not be instructed to recover any identifier value following the synchronize cache command.

In some examples, if the system is in a second mode or a “lazy” mode, if there is a successful synchronize cache command, rather than have one or more commands reporting a status back to a host system, the system may write the data associated with identifiers 1-4 and may trust that that a device will rebuild to the last point that it can based on the successful synchronize cache. In the circumstance of asynchronous power loss or a system reset where the system may not be able to recover certain data because it was stored in volatile memory, such as a cache, in a second or lazy mode, the system may guarantee the ordering of the sequence so that recovery of data is possible. For example, if there is a synchronize cache command between identifier 4 and identifier 5, the system may guarantee the identifier order so that if identifier 5 is found to be valid, then identifier 1 through 4 may also be considered valid. In some examples, in second mode or lazy mode, the system may guarantee that once data is written, the sequence ordering is correct.

In some examples, in second or lazy mode, a data recovery procedure may be based on the sequence ordering of commands. For example, if a synchronize cache command, or the like, was unsuccessful between identifier 4 and identifier 5, the memory system may assume that data associated with identifiers 1-4 is stored in non-volatile memory and data associated with identifiers following 1-4 is invalid and not to be recovered. In some examples, using the second mode or lazy mode, the system may continue to execute write commands in a command sequence because the system may not have to stop if the synchronize cache command occurs. In some examples, a system may perform a relatively large quantity of synchronize cache commands at regular intervals to prepare to recover data in the event of an asynchronous power loss o. Reducing the frequency of execution of synchronize cache commands may improve system performance while maintaining a similar ability to recover lost data in the event of an asynchronous power failure, or the like. In some examples, a memory system may switch between a first mode (e.g., normal mode) and a second mode (e.g., lazy mode) based on system conditions.

In some examples, the memory system may receive a series of commands including a synchronize cache command, a FUA command, or the like. The system may mark where that synchronize cache, FUA, or the like, command is received in the sequence, and may ensure that any data that was received before the command is valid. The system may not stop to interrupt the series of commands, but the system may mark the spot in time if the command occurs and may assume that the series of commands before the synchronize cache, FUA, or the like is valid and anything after may not be valid. In some examples, a sequence command may be incremented following a synchronize cache command, or the like. The host system or memory system may select between relatively higher performance with the second mode or relatively higher reliability with the first mode.

In some examples, a memory system may request the contents of a cache to be written directly to an underlying non-volatile array (e.g., a NAND array) via a synchronize command. A synchronize command may be an example of a FUA command or a synchronize cache command, or the like. Some applications may not require compliancy with a synchronize cache command and may allow a data write to be delayed to a later time in favor of faster latency and performance, or the like. In some examples, the system may prioritize refreshing data which is more frequently accessed and data which is needed by a system and may postpone the refresh of the remaining data.

In some examples, a memory system may operate according to a first mode (e.g., a regular mode) and a second mode (e.g., a lazy mode). The first mode may be the default value at boot. Under the first mode, the memory system may honor, for example, write FUA requests and synchronize cache (e.g., SYNC_CACHE) commands. In some examples, under the second mode or lazy mode, a memory device may not honor, for example, write FUA and synchronize cache commands. In some examples, under the second mode, a memory device may not guarantee that after completing, for example, a write FUA or synchronize cache command, the contents are stored in a non-volatile storage (e.g., a NAND Array), as the data may still be stored in the volatile cache.

In some examples, a memory system may read and write according to a configuration setting to alter the state of a storage device. For example, a memory device may not change the configuration setting unless a system (e.g., a host system) provides a configuration setting write command (e.g., an attribute write, or a query descriptor write command). Some examples of this memory system could be included in various storage protocols (e.g., NVMe, eMMC, UFS, etc.). In a UFS example, a memory device may include a set of flags that may be used as control settings for the memory device. A flag may be named, for example, fLazySyncModeEn, may reflect the above configuration and be available for the memory system to set. For example, if the flag is set to a first value (e.g., 0b), the device may be in a regular mode and if the flag is set to a second value (e.g., 1b), the device may be in a lazy mode. In some examples, a flag may be readable by the memory system and writable with its state persisting across power cycles. Reads and writes of these modes may be accomplished using, for example, UFS's standardized QUERY REQUEST and QUERY RESPONSE UPIUs.

In some examples, if device is in a second mode or lazy mode, there may be memory device level behavioral changes. For example, a memory device may hold a requested write FUA data, synchronize cache data, or the like, in a volatile cache. In some examples, a memory device may guarantee ordering of data, for example, if a write FUA command or synchronize cache command is received. The ordering may ensure that data written before a write FUA command, a synchronize cache command, or the like, may be stored in a non-volatile memory device and thus may be valid. In some examples, if a write command such as a write FUA or synchronize cache command is executed, write data may be written in non-volatile memory and may be considered valid before any additional write data issued after the command may be considered valid. By writing the valid data to a cache as described herein, a memory system can recover the prior data (e.g., the data written to the non-volatile memory) faster after a power loss event, which may improve the overall performance of the memory system.

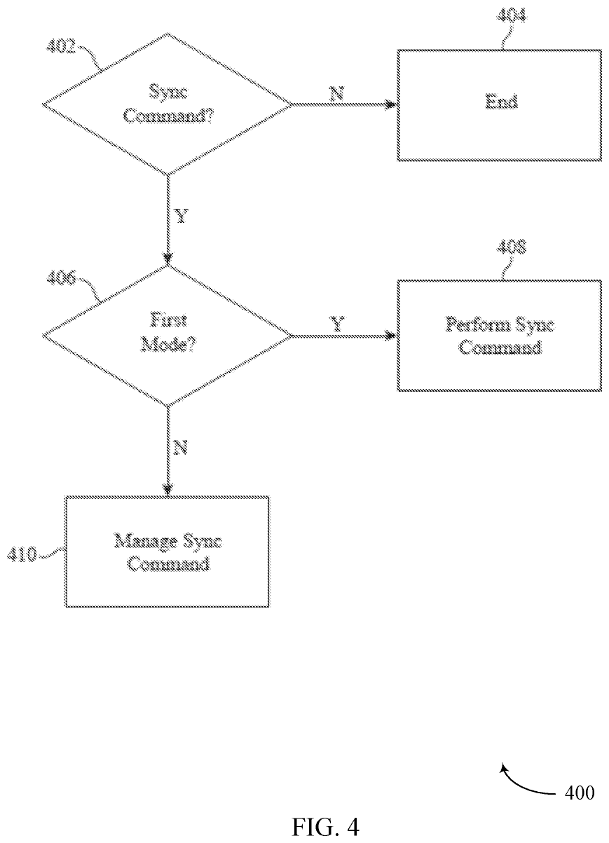

FIG. 4 illustrates a flowchart showing a method 400 or methods of a command sequence that supports memory device cache synchronization in accordance with examples as disclosed herein. The operations of method 400 may be implemented by a memory system or its components as described herein. For example, the operations of method 400 may be performed by a memory system as described with reference to FIG. 1. In some examples, a memory system may execute a set of instructions to control the functional elements of a device to perform the described functions. Additionally, or alternatively, the memory system may perform aspects of the described functions using special-purpose hardware.

At 402, the method may include determining whether a synchronize command is received. If a synchronize command is not received, the method may end at 404. In some examples, the memory system may operate in different modes of operation. For example, a first mode of operation may be a normal mode of operation and a second mode of operation may be a lazy mode of operation. If a synchronize command is received, at 406 the memory system may identify if a specified mode of operation is to be used. For example, if a first mode of operation (e.g., normal operation) is to be used, the memory system may perform a sync command at 408.

If a second mode of operation (e.g., lazy mode) is to be used, the memory system may manage the sync command at 410 and either execute it as it would during normal mode or delay execution of the synchronize command, but in either case the memory system may issue an indication that the synchronize command is being executed or has executed so that other system commands are not delayed, even if the synchronize command will not be executed until a later time. By managing sync commands as described herein, the memory system can recover prior data (e.g., the data written to a non-volatile memory) faster after a power loss event, which may improve the overall performance of the memory system.

FIG. 5 illustrates a block diagram 500 of a memory system 520 that supports memory device cache synchronization in accordance with examples as disclosed herein. The memory system 520 may be an example of aspects of a memory system as described with reference to FIGS. 1 through 4. The memory system 520, or various components thereof, may be an example of means for performing various aspects of memory device cache synchronization as described herein. For example, the memory system 520 may include a storing component 525, a writing component 530, a power component 535, a determination component 540, a reception component 545, a transmission component 550, an identification component 555, or any combination thereof. Each of these components may communicate, directly or indirectly, with one another (e.g., via one or more buses).

The storing component 525 may be configured as or otherwise support a means for storing data associated with each write command of a plurality of write commands to a cache of a memory system. The writing component 530 may be configured as or otherwise support a means for writing a subset of the data stored to the cache to a non-volatile memory of the memory system based at least in part on storing the data associated with each of the plurality of write commands to the cache, where a plurality of identifiers is associated with the subset of data, where each data of the subset of data is associated with a respective identifier of the plurality of identifiers. The power component 535 may be configured as or otherwise support a means for transitioning power states, by the memory system, based at least in part on writing the subset of the data to the non-volatile memory. The determination component 540 may be configured as or otherwise support a means for determining, after transitioning power states, whether the subset of the data was written to the non-volatile memory based at least in part on the plurality identifiers. In some examples, the writing component 530 may be configured as or otherwise support a means for writing the subset of the data stored to the non-volatile memory to the cache based at least in part on determining that the subset of the data was written to the non-volatile memory.

In some examples, a second subset of the data stored to the cache is associated with a second plurality of identifiers, and the determination component 540 may be configured as or otherwise support a means for determining, after transitioning power states, that the second subset of the data was not written to the non-volatile memory based at least in part on a first identifier of the second plurality of identifiers associated with the second subset of data.

In some examples, the identification component 555 may be configured as or otherwise support a means for identifying, in response to the determining that the second subset of the data was not written to the non-volatile memory, the second subset of the data as invalid data and notifying a host system of the invalid data.

In some examples, the reception component 545 may be configured as or otherwise support a means for receiving, by the memory system, a command prior to transitioning power states. In some examples, the storing component 525 may be configured as or otherwise support a means for storing an indication of the data written to the non-volatile memory based at least in part on receiving the command, where the indication is based at least in part on a second identifier of the plurality of identifiers, and where determining that the subset of the data was written to the non-volatile memory is based at least in part on storing the indication.

In some examples, the command includes a Force Unit Access (FUA) write command.

In some examples, the command includes a synchronize cache command.

In some examples, the second identifier indicates the subset of data is valid.

In some examples, the second identifier is associated with a last portion of the subset of data that was written to the non-volatile memory.

In some examples, the plurality of identifiers includes a plurality of sequential identifiers. In some examples, a sequence of the plurality of sequential identifiers is associated with an order that the associated data is written to the non-volatile memory.

In some examples, the storing component 525 may be configured as or otherwise support a means for storing data associated with each write command of a plurality of second write commands to the cache. In some examples, the reception component 545 may be configured as or otherwise support a means for receiving, by the memory system, a first type of command based at least in part on storing the data associated with each write command of the plurality of second write commands to the cache. In some examples, the storing component 525 may be configured as or otherwise support a means for maintaining, for a first duration, the data in the cache based at least in part on receiving the first type of command. In some examples, the writing component 530 may be configured as or otherwise support a means for writing, after the first duration, the data to the non-volatile memory.

In some examples, the storing component 525 may be configured as or otherwise support a means for storing data associated with each write command of a plurality of third write commands to the cache. In some examples, the reception component 545 may be configured as or otherwise support a means for receiving, by the memory system, a second type of command based at least in part on storing the data associated with each write command of the plurality of third write commands to the cache. In some examples, the storing component 525 may be configured as or otherwise support a means for maintaining, for a second duration, the data in the cache based at least in part on receiving the second type of command. In some examples, the writing component 530 may be configured as or otherwise support a means for writing, after the second duration, the data to the non-volatile memory.

In some examples, the reception component 545 may be configured as or otherwise support a means for receiving, from a host system, a command to enter the first mode of operation. In some examples, the power component 535 may be configured as or otherwise support a means for transitioning, by the memory system, from a second mode of operation to the first mode of operation. In some examples, the transmission component 550 may be configured as or otherwise support a means for transmitting, to the host system, an indication that the memory system has transitioned from the second mode of operation to the first mode of operation.

In some examples, to support transitioning power states, the power component 535 may be configured as or otherwise support a means for transitioning, by the memory system, from a first power state to a second power state. In some examples, to support transitioning power states, the power component 535 may be configured as or otherwise support a means for transitioning, by the memory system, from the second power state to the first power state.

In some examples, the first power state includes a powered-on state.

In some examples, the second power state includes a powered-off state.

In some examples, the non-volatile memory includes NAND memory.

In some examples, the transitioning power states occurs in response to loss of power and restoration of power.

In some examples, the loss of power is an asynchronous loss of power.

In some examples, the subset of data is determined to be written if the identifier is lower than a synchronization indication value.

In some examples, the synchronization indication value is an indication of if a command to perform a synchronization was received.

In some examples, writing the subset of the data stored to the non-volatile memory to the cache occurs in response to power restoration to the system.

In some examples, power restoration to the system occurs after an asynchronous power loss.

FIG. 6 illustrates a flowchart showing a method 600 that supports memory device cache synchronization in accordance with examples as disclosed herein. The operations of method 600 may be implemented by a memory system or its components as described herein. For example, the operations of method 600 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 605, the method may include storing data associated with each write command of a plurality of write commands to a cache of a memory system. The operations of 605 may be performed in accordance with examples as disclosed herein. In some examples, aspects of the operations of 605 may be performed by a storing component 525 as described with reference to FIG. 5.

At 610, the method may include writing a subset of the data stored to the cache to a non-volatile memory of the memory system based at least in part on storing the data associated with each of the plurality of write commands to the cache, where a plurality of identifiers is associated with the subset of data, where each data of the subset of data is associated with a respective identifier of the plurality of identifiers. The operations of 610 may be performed in accordance with examples as disclosed herein. In some examples, aspects of the operations of 610 may be performed by a writing component 530 as described with reference to FIG. 5.

At 615, the method may include transitioning power states, by the memory system, based at least in part on writing the subset of the data to the non-volatile memory. The operations of 615 may be performed in accordance with examples as disclosed herein. In some examples, aspects of the operations of 615 may be performed by a power component 535 as described with reference to FIG. 5.

At 620, the method may include determining, after transitioning power states, whether the subset of the data was written to the non-volatile memory based at least in part on the plurality identifiers. The operations of 620 may be performed in accordance with examples as disclosed herein. In some examples, aspects of the operations of 620 may be performed by a determination component 540 as described with reference to FIG. 5.

At 625, the method may include writing the subset of the data stored to the non-volatile memory to the cache based at least in part on determining that the subset of the data was written to the non-volatile memory. The operations of 625 may be performed in accordance with examples as disclosed herein. In some examples, aspects of the operations of 625 may be performed by a writing component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for storing data associated with each write command of a plurality of write commands to a cache of a memory system; writing a subset of the data stored to the cache to a non-volatile memory of the memory system based at least in part on storing the data associated with each of the plurality of write commands to the cache, where a plurality of identifiers is associated with the subset of data, where each data of the subset of data is associated with a respective identifier of the plurality of identifiers; transitioning power states, by the memory system, based at least in part on writing the subset of the data to the non-volatile memory; determining, after transitioning power states, whether the subset of the data was written to the non-volatile memory based at least in part on the plurality identifiers; and writing the subset of the data stored to the non-volatile memory to the cache based at least in part on determining that the subset of the data was written to the non-volatile memory.

Aspect 2: The method, apparatus, or non-transitory computer-readable medium of aspect 1, where a second subset of the data stored to the cache is associated with a second plurality of identifiers and the method, apparatuses, and non-transitory computer-readable medium further includes operations, features, circuitry, logic, means, or instructions, or any combination thereof for determining, after transitioning power states, that the second subset of the data was not written to the non-volatile memory based at least in part on a first identifier of the second plurality of identifiers associated with the second subset of data.

Aspect 3: The method, apparatus, or non-transitory computer-readable medium of aspect 2, further including operations, features, circuitry, logic, means, or instructions, or any combination thereof for identifying, in response to the determining that the second subset of the data was not written to the non-volatile memory, the second subset of the data as invalid data and notifying a host system of the invalid data.

Aspect 4: The method, apparatus, or non-transitory computer-readable medium of any of aspects 1 through 3, further including operations, features, circuitry, logic, means, or instructions, or any combination thereof for receiving, by the memory system, a command prior to transitioning power states and storing an indication of the data written to the non-volatile memory based at least in part on receiving the command, where the indication is based at least in part on a second identifier of the plurality of identifiers, and where determining that the subset of the data was written to the non-volatile memory is based at least in part on storing the indication.

Aspect 5: The method, apparatus, or non-transitory computer-readable medium of aspect 4, where the command includes a Force Unit Access (FUA) write command.

Aspect 6: The method, apparatus, or non-transitory computer-readable medium of any of aspects 4 through 5, where the command includes a synchronize cache command.

Aspect 7: The method, apparatus, or non-transitory computer-readable medium of any of aspects 4 through 6, where the second identifier indicates the subset of data is valid.

Aspect 8: The method, apparatus, or non-transitory computer-readable medium of any of aspects 4 through 7, where the second identifier is associated with a last portion of the subset of data that was written to the non-volatile memory.

Aspect 9: The method, apparatus, or non-transitory computer-readable medium of any of aspects 1 through 8, where the plurality of identifiers includes a plurality of sequential identifiers and a sequence of the plurality of sequential identifiers is associated with an order that the associated data is written to the non-volatile memory.

Aspect 10: The method, apparatus, or non-transitory computer-readable medium of any of aspects 1 through 9, further including operations, features, circuitry, logic, means, or instructions, or any combination thereof for storing data associated with each write command of a plurality of second write commands to the cache; receiving, by the memory system, a first type of command based at least in part on storing the data associated with each write command of the plurality of second write commands to the cache; maintaining, for a first duration, the data in the cache based at least in part on receiving the first type of command; and writing, after the first duration, the data to the non-volatile memory.

Aspect 11: The method, apparatus, or non-transitory computer-readable medium of any of aspects 1 through 10, further including operations, features, circuitry, logic, means, or instructions, or any combination thereof for storing data associated with each write command of a plurality of third write commands to the cache; receiving, by the memory system, a second type of command based at least in part on storing the data associated with each write command of the plurality of third write commands to the cache; maintaining, for a second duration, the data in the cache based at least in part on receiving the second type of command; and writing, after the second duration, the data to the non-volatile memory.

Aspect 12: The method, apparatus, or non-transitory computer-readable medium of any of aspects 1 through 11, where the method, apparatuses, and non-transitory computer-readable medium further includes operations, features, circuitry, logic, means, or instructions, or any combination thereof for receiving, from a host system, a command to enter the first mode of operation; transitioning, by the memory system, from a second mode of operation to the first mode of operation; and transmitting, to the host system, an indication that the memory system has transitioned from the second mode of operation to the first mode of operation.

Aspect 13: The method, apparatus, or non-transitory computer-readable medium of any of aspects 1 through 12, where transitioning power states includes operations, features, circuitry, logic, means, or instructions, or any combination thereof for transitioning, by the memory system, from a first power state to a second power state and transitioning, by the memory system, from the second power state to the first power state.

Aspect 14: The method, apparatus, or non-transitory computer-readable medium of aspect 13, where the first power state includes a powered-on state.

Aspect 15: The method, apparatus, or non-transitory computer-readable medium of any of aspects 13 through 14, where the second power state includes a powered-off state.

Aspect 16: The method, apparatus, or non-transitory computer-readable medium of any of aspects 1 through 15, where the non-volatile memory includes NAND memory.

Aspect 17: The method, apparatus, or non-transitory computer-readable medium of any of aspects 1 through 16, where the transitioning power states occurs in response to loss of power and restoration of power.

Aspect 18: The method, apparatus, or non-transitory computer-readable medium of aspect 17, where the loss of power is an asynchronous loss of power.

Aspect 19: The method, apparatus, or non-transitory computer-readable medium of any of aspects 1 through 18, where the subset of data is determined to be written if the identifier is lower than a synchronization indication value.

Aspect 20: The method, apparatus, or non-transitory computer-readable medium of aspect 19, where the synchronization indication value is an indication of if a command to perform a synchronization was received.

Aspect 21: The method, apparatus, or non-transitory computer-readable medium of any of aspects 1 through 20, where writing the subset of the data stored to the non-volatile memory to the cache occurs in response to power restoration to the system.

Aspect 22: The method, apparatus, or non-transitory computer-readable medium of aspect 21, where power restoration to the system occurs after an asynchronous power loss.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” may not be construed as a reference to a closed set of conditions. For example, an exemplary step that is described as “based on condition A” may be based on both a condition A and a condition B without departing from the scope of the present disclosure. In other words, as used herein, the phrase “based on” may be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
one or more controllers associated with a memory system, wherein the one or more controllers are configured to cause the apparatus to:
store data associated with each write command of a plurality of write commands to a cache of the memory system;
write a subset of the data stored to the cache to a non-volatile memory of the memory system based at least in part on storing the data associated with each of the plurality of write commands to the cache, wherein a plurality of identifiers are associated with the subset of data, wherein each data of the subset of data is associated with a respective identifier of the plurality of identifiers;
transition power states, by the memory system, based at least in part on writing the subset of the data to the non-volatile memory;
determine, after transitioning power states, whether the subset of the data was written to the non-volatile memory based at least in part on the plurality of identifiers; and
write the subset of the data stored to the non-volatile memory to the cache based at least in part on determining that the subset of the data was written to the non-volatile memory.

2. The apparatus of claim 1, wherein a second subset of the data stored to the cache is associated with a second plurality of identifiers, and the one or more controllers are further configured to cause the apparatus to:
determine, after transitioning power states, that the second subset of the data was not written to the non-volatile memory based at least in part on a first identifier of the second plurality of identifiers associated with the second subset of data.

3. The apparatus of claim 1, wherein the one or more controllers are further configured to cause the apparatus to:
receive, by the memory system, a command prior to transitioning power states; and
store an indication of the data written to the non-volatile memory based at least in part on receiving the command, wherein the indication is based at least in part on a second identifier of the plurality of identifiers, and wherein determining that the subset of the data was written to the non-volatile memory is based at least in part on storing the indication.

4. The apparatus of claim 3, wherein the second identifier is associated with a last portion of the subset of data that was written to the non-volatile memory.

5. The apparatus of claim 1, wherein:
the plurality of identifiers comprise a plurality of sequential identifiers; and
a sequence of the plurality of sequential identifiers is associated with an order that the associated data is written to the non-volatile memory.

6. The apparatus of claim 1, wherein the one or more controllers are further configured to cause the apparatus to:
store data associated with each write command of a plurality of second write commands to the cache;
receive, by the memory system, a first type of command based at least in part on storing the data associated with each write command of the plurality of second write commands to the cache;
maintain, for a first duration, the data in the cache based at least in part on receiving the first type of command; and
write, after the first duration, the data to the non-volatile memory.

7. The apparatus of claim 1, wherein the one or more controllers are further configured to cause the apparatus to:
store data associated with each write command of a plurality of third write commands to the cache;
receive, by the memory system, a second type of command based at least in part on storing the data associated with each write command of the plurality of third write commands to the cache;
maintain, for a second duration, the data in the cache based at least in part on receiving the second type of command; and
write, after the second duration, the data to the non-volatile memory.

8. The apparatus of claim 1, wherein the one or more controllers are configured to store the data to the cache while the memory system is operating in a first mode, and the one or more controllers are further configured to cause the apparatus to:
receive, from a host system, a command to enter the first mode of operation;
transition, by the memory system, from a second mode of operation to the first mode of operation; and
transmit, to the host system, an indication that the memory system has transitioned from the second mode of operation to the first mode of operation.

9. The apparatus of claim 1, wherein transitioning power states is configured to cause the apparatus to:
transition, by the memory system, from a first power state to a second power state; and
transition, by the memory system, from the second power state to the first power state.

10. A non-transitory computer-readable medium storing code comprising instructions which, when executed by a processor of an electronic device, cause the electronic device to:
store data associated with each write command of a plurality of write commands to a cache of a memory system;
write a subset of the data stored to the cache to a non-volatile memory of the memory system based at least in part on storing the data associated with each of the plurality of write commands to the cache, wherein a plurality of identifiers are associated with the subset of data, wherein each data of the subset of data is associated with a respective identifier of the plurality of identifiers;
transition power states, by the memory system, based at least in part on writing the subset of the data to the non-volatile memory;
determine, after transitioning power states, whether the subset of the data was written to the non-volatile memory based at least in part on the plurality of identifiers; and
write the subset of the data stored to the non-volatile memory to the cache based at least in part on determining that the subset of the data was written to the non-volatile memory.

11. The non-transitory computer-readable medium of claim 10, wherein a second subset of the data stored to the cache is associated with a second plurality of identifiers, and wherein the instructions, when executed by the processor of the electronic device, further cause the electronic device to:
determine, after transitioning power states, that the second subset of the data was not written to the non-volatile memory based at least in part on a first identifier of the second plurality of identifiers associated with the second subset of data.

12. The non-transitory computer-readable medium of claim 10, wherein the instructions, when executed by the processor of the electronic device, further cause the electronic device to:
receive, by the memory system, a command prior to transitioning power states; and
store an indication of the data written to the non-volatile memory based at least in part on receiving the command, wherein the indication is based at least in part on a second identifier of the plurality of identifiers, and wherein determining that the subset of the data was written to the non-volatile memory is based at least in part on storing the indication.

13. The non-transitory computer-readable medium of claim 12, wherein the second identifier is associated with a last portion of the subset of data that was written to the non-volatile memory.

14. The non-transitory computer-readable medium of claim 10, wherein:
the plurality of identifiers comprise a plurality of sequential identifiers; and
a sequence of the plurality of sequential identifiers is associated with an order that the associated data is written to the non-volatile memory.

15. The non-transitory computer-readable medium of claim 10, wherein the instructions, when executed by the processor of the electronic device, further cause the electronic device to:
store data associated with each write command of a plurality of second write commands to the cache;
receive, by the memory system, a first type of command based at least in part on storing the data associated with each write command of the plurality of second write commands to the cache;
maintain, for a first duration, the data in the cache based at least in part on receiving the first type of command; and
write, after the first duration, the data to the non-volatile memory.

16. The non-transitory computer-readable medium of claim 10, wherein the instructions, when executed by the processor of the electronic device, further cause the electronic device to:
store data associated with each write command of a plurality of third write commands to the cache;
receive, by the memory system, a second type of command based at least in part on storing the data associated with each write command of the plurality of third write commands to the cache;
maintain, for a second duration, the data in the cache based at least in part on receiving the second type of command; and
write, after the second duration, the data to the non-volatile memory.

17. The non-transitory computer-readable medium of claim 10, wherein storing the data to the cache occurs while the memory system is operating in a first mode, and wherein the instructions, when executed by the processor of the electronic device, further cause the electronic device to:
receive, from a host system, a command to enter the first mode of operation;
transition, by the memory system, from a second mode of operation to the first mode of operation; and
transmit, to the host system, an indication that the memory system has transitioned from the second mode of operation to the first mode of operation.

18. The non-transitory computer-readable medium of claim 10, wherein the instructions, when executed by the processor of the electronic device, further cause the electronic device to:
transition, by the memory system, from a first power state to a second power state; and
transition, by the memory system, from the second power state to the first power state.

19. A method, comprising:
storing data associated with each write command of a plurality of write commands to a cache of a memory system;
writing a subset of the data stored to the cache to a non-volatile memory of the memory system based at least in part on storing the data associated with each of the plurality of write commands to the cache, wherein a plurality of identifiers are associated with the subset of data, wherein each data of the subset of data is associated with a respective identifier of the plurality of identifiers;
transitioning power states, by the memory system, based at least in part on writing the subset of the data to the non-volatile memory;
determining, after transitioning power states, whether the subset of the data was written to the non-volatile memory based at least in part on the plurality of identifiers; and
writing the subset of the data stored to the non-volatile memory to the cache based at least in part on determining that the subset of the data was written to the non-volatile memory.

20. The method of claim 19, wherein a second subset of the data stored to the cache is associated with a second plurality of identifiers, the method further comprising:
determining, after transitioning power states, that the second subset of the data was not written to the non-volatile memory based at least in part on a first identifier of the second plurality of identifiers associated with the second subset of data.
